(19) United States
(12) Patent Application Publication
(10) Pub. No.: US 2010/0208092 A1
(43) Pub. Date: Aug. 19, 2010

(54) Method of accelerating image capturing process and digital image-capturing apparatus

(76) Inventor: Chun-Chang Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,309

(22) Filed: Aug. 7, 2009

(30) Foreign Application Priority Data
Feb. 18, 2009 (TW) 98105096

(51) Int. Cl. H04N 5/228; H04N 5/335

(52) U.S. Cl. 348/222.1; 348/294; 348/E05.031; 348/E05.091

(57) ABSTRACT

A method of accelerating image capturing process is provided. The steps of the method are as follows: first, dividing a frame into a plurality of regions by using a plurality of dividing lines; respectively choosing the regions alternatingly as a region of read out timing or a region of sweep timing; setting the regions of read out timing as a window of interest region; and executing a timing outputting process for capturing an image frame from the window of interest region.

### BACKGROUND OF THE INVENTION

1. Field of the Invention

The present invention relates to a method of image capturing process and an image-capturing apparatus, in particular, to a method of accelerating image capturing process via capturing segmentation images and a digital image-capturing apparatus.

2. Description of Related Art

Digital image-capturing apparatus (such as a digital camera) provides a fast and convenient way for a user to take pictures, but as various digital image-capturing apparatus becomes more common, users are becoming more particular over the requirements and functions of these digital image-capturing apparatus. Therefore, in terms of the function of autofocus, how to use less time to achieve autofocus without affecting the accuracy of the focus is becoming a factor of consideration for users when selecting and purchasing digital image-capturing apparatus.

How autofocus is achieved according to prior art is shown by FIG. 1, such that a complete image frame is received and loaded for image analyses, yet in order to download a complete image frame the required time is long. Therefore, later on, the manufacturers of the image-capturing apparatus attempt to shorten the time required to receive and load the necessary image frame for autofocus analysis, take the approach as shown in FIG. 2. Therein, only the middle part of the original image frame has been loaded and received, and the top and bottom portion of the image frame has been skipped, therefore, the amount of data associated with a received image frame is decreased, so that the time required for autofocus to complete is decreased.

Although the method of autofocus demonstrated by FIG. 2 accelerates the autofocus process, the received image frame doesn't consistent with the original image frame, thereby the received image frame is no longer fit for display and is only provided for autofocus analysis due to the fact that the top and bottom portion of the image frame is trimmed The effect is that while a prior art digital image-capturing apparatus is attempting autofocus, the digital image-capturing apparatus temporarily stop displaying currently captured image frame, and instead display a last received image frame just prior to attempting autofocus. So that for a user, when attempting autofocus function, the display of the prior art digital image-capturing apparatus is temporarily halted, thereby the effect of live view is not continuously achieved.

### SUMMARY OF THE INVENTION

In view of the aforementioned issues, the present invention provides a method for accelerating image capturing process and a digital image-capturing apparatus, thereby a timing generator unit within the digital image-capturing apparatus generates dynamic timing, so as to capture a frame in segments of regions and simultaneously maintain the ratio of original image frame, thus resolving the aforementioned issues of the prior art.

In order to achieve the aforementioned objectives, the present invention provides a method for accelerating image capturing process, suitable for use for an image processing procedure of a digital image-capturing apparatus, the steps of the method includes: first, dividing a frame that is captured by the digital image-capturing apparatus by using a plurality of dividing lines, so as to form a plurality of regions; then defining the regions as respectively either a region of read out timing or a region of sweep timing, wherein every m number regions of read out timing and every n number regions of sweep timing are adjacently located with one of the dividing lines in between; next, setting the regions of read out timing as a window of interest region; and lastly outputting the timing signal required by the read out timing and the sweep timing so as to capture the image data that is contained within the window of interest region.

To achieve the aforementioned objectives, the present invention further provides a digital image-capturing apparatus, the apparatus includes: a control unit, an imaging unit, a driving unit, and a timing generator unit. Therein the control unit is for controlling the operation of the digital image-capturing apparatus. The imaging device is coupled to the control unit, and the imaging device is for providing image capture. The timing generator unit is coupled to the control unit, and the timing generator unit is for providing a plurality of timing signals required for the operation of the imaging device; and the driving unit is coupled to the timing generator unit, and the driving unit is for driving the imaging device according to the timing signals provided by the timing generator unit.

Therein, the aforementioned control unit includes the following:

a dividing module, for dividing a frame that is captured by the imaging device by using a plurality of dividing lines, so that the frame forms a plurality of regions;

a differentiation module; for defining the regions as respectively either a region of read out timing or a region of sweep timing, wherein every m number regions of read out timing and every n number regions of sweep timing are adjacently located with one of the divided lines in between;

a window of interest selection module, for setting the regions of read out timing as a window of interest region; and

an output module, for controlling the timing generator unit so as to output the timing signal required by the read out timing and the sweep timing and thereby capture the image data that is contained within the window of interest region.

Consequently, the following efficacy of aforementioned technical proposal of the present invention is achieved: the timing signal that is generated and outputted by the timing generator unit continuously retrieves and uploads the segmented image contained within the frame, thereby the consequence of accelerating image capturing process is achieved; furthermore, the retrieved image frame is used for simultaneous display and is consistent with the original image frame at the same frame ratio, and thereby the digital image-capturing apparatus when executing image processing still accomplishes the effect of live view.

In order to further understand the techniques, means, and effects the present invention takes for achieving the prescribed objectives, the following detailed descriptions and appended drawings are hereby referred, such that, through which, the purposes, features, and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 is a schematic diagram of an original image frame according to the prior art;

FIG. 2 is a schematic diagram of FIG. 1 after autofocus as according to the prior art;

FIG. 3 is a functional block diagram of an image-capturing apparatus as according to an embodiment of the present invention;

FIG. 4 is a functional block diagram of a control unit as according to an embodiment of the present invention;

FIG. 5 is a flowchart of the method for accelerating image capturing process as according to the present invention;

FIG. 6 is a schematic diagram of a frame being divided as according to the present invention;

FIG. 7 is a timing diagram of a frame being scanned as according to the present invention;

FIG. 8 is a schematic diagram of the frame with line skip; and

FIG. 9 is a schematic diagram of the frame formed after the line skip of FIG. 8.

### DETAILED DESCRIPTION OF THE PREFERRED EMBODIMENTS

The present invention primarily uses a sweep timing to intermittently remove some of the line images of a frame, so that an image may be reduced while still maintaining the overall ratio of original image frame, and because the image frame has been decreased so that the frame rate of the frame is correspondingly increased, thereby via this way a digital image-capturing apparatus of the present invention can proceed with an image processing procedure, so as to accomplish the object of accelerating image capturing process.

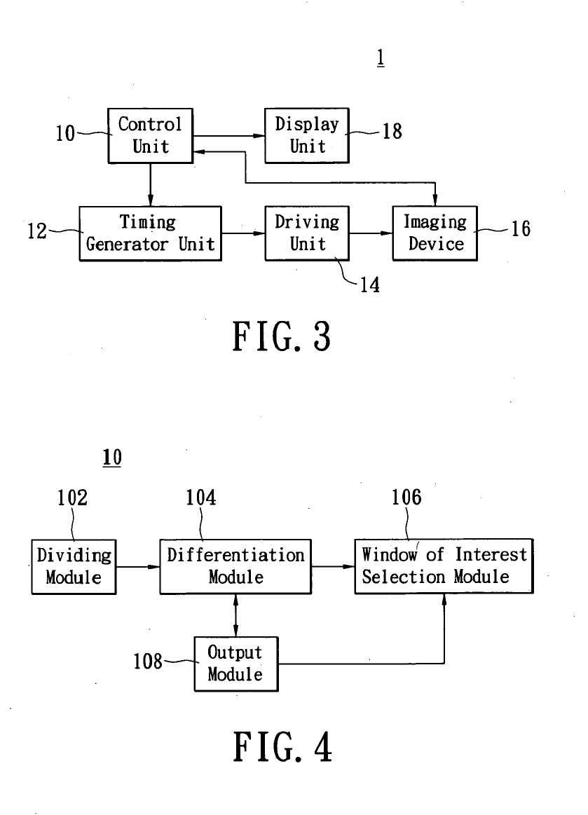

Initially, please refer to FIG. 3, wherein the digital image-capturing apparatus 1 of FIG. 3 is primarily for capturing image input. The digital image-capturing apparatus 1 includes: a control unit 10, a timing generator unit 12, a driving unit 14, an imaging device 16, and a display unit 18. The control unit 10, is the core of controlling for the digital image-capturing apparatus 1, coupled to the timing generator unit 12, the imaging device 16, and the display unit 18, respectively. Thus, the control unit 10 controls the overall operation of the digital image-capturing apparatus 1, and more particularly, to the execution of an image processing procedure, which is listed below as an embodiment for explanation.

The timing generator unit 12 is coupled to the control unit 10, and the timing generator unit 12 is for providing and outputting timing signals required for the operation of the imaging device 16 (such as a vertical pulse signal or a horizontal pulse signal). The driving unit 14 is coupled to the timing generator unit 12, for driving the imaging device 16 according to the timing signals outputted by the timing generator unit 12. The imaging device 16 is an image sensor device that is composed of charge coupled device (CCD) or complementary metal-oxide-semiconductor (CMOS). The digital image-capturing apparatus 1 of the present embodiment can be considered as an electronic device with digital camera function. The display unit 18 is coupled to the control unit 10, for displaying frame information according to the control of the control unit 10.

In the present embodiment, the digital image-capturing apparatus 1 can provide the functionality of accelerating image capturing during an image processing procedure. More specifically, this image processing procedure is considered as the image capturing process performed for autofocus (AF), and thereby via retrieving the image faster, the time required for autofocus is shortened, and furthermore the overall ratio of image frame retrieved by autofocus can be simultaneously displayed on the display unit 18, due to the fact the retrieved image frame maintains the same ratio as the original image frame. Consequently, users can simultaneously observe live view of image frame while performing autofocus, and the issue of having image temporarily halted does not occur.

In addition, the image capturing process performed by the imaging device 16 can include a electric charge dump timing, a sweep timing, and a read out timing; Furthermore, the starting and ending of each image capturing process can be controlled according to the timing signals outputted by the timing generator unit 12.

Moreover, in order to achieve the functionality of accelerating image capturing, the present embodiment can regulate the length of each line of the imaging device 16 while scanning; thereby the present embodiment is able to capture the desired image data from a frame according to a window of interest region without including dummy data. More detailed description of this technical means and effect shall be described further later. Yet to summarize, the timing generator unit 12 of the present embodiment, in order to fulfill the aforementioned operation and functionality of accelerating image capturing, correspondingly provides dynamic timing output, so as to provide various length of timing signal generated by the timing generator unit 12 while scanning each line of the imaging device 16.

Next is the specific explanation for the operation of the control unit 10. Please refer to FIG. 4. Control unit 10 includes a dividing module 102, a differentiation module 104, a window of interest selection module 106, and an output module 108. Therein, the dividing module 102 is for dividing a frame that is captured by the imaging device 16; more specifically, the dividing module 102 is for dividing a frame that is captured by the imaging device 16 by using a plurality of dividing lines, so that the frame forms a plurality of regions, wherein the basic length of each region matches the display width of the frame.

The differentiation module 104 proceeds with arranging of the image capturing procedure for the plurality of regions that forms the frame, wherein the arranging is done according to the dividing result of the dividing module 102. Specifically speaking, the differentiation module 104 of the present embodiment is for defining the regions of the frame as respectively either a region of read out timing or a region of sweep timing, wherein every m number regions of read out timing and every n number regions of sweep timing are adjacently located with one of the divided lines in between. Therein, the aforementioned m and n are each integer value that is greater than 1 or equal to 1.

The window of interest selection module 106 is for setting the regions of read out timing as a window of interest region according to how the differentiation module 104 has defined the plurality of regions that forms the frame. Therein the regions of sweep timing which has not been selected as part of the window of interest region are eliminated; therefore the amount of data of the window of interest region is decreased when compared to retrieving a complete image data without elimination, and thereby accelerating the image capturing process. Furthermore the regions of read out timing that compose the window of interest region are arranged adjacently once the regions of sweep timing have been eliminated. In other words, the regions of read out timing that compose the window of interest region are arranged continuously, therefore the final retrieved image from the window of interest region can maintain the same ratio as the original image frame.

The output module 108 is for controlling the timing generator unit 12 according to the process result of the differentiation module 104 and the window of interest selection module 106, so as to output the timing signal required by the read out timing and the sweep timing and thereby capture the image data that is contained within he window of interest region.

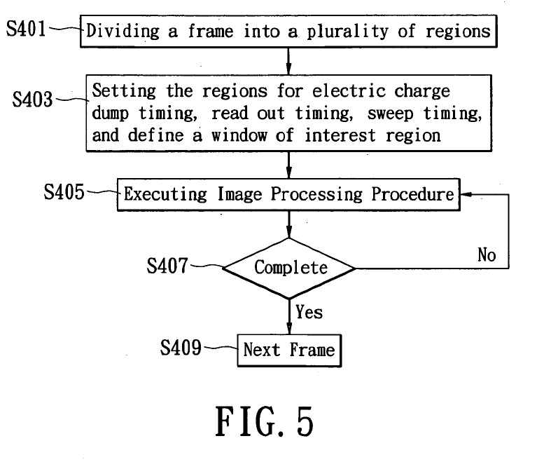

Next is the further explanation of the method of accelerating image capturing process for the digital image-capturing apparatus 1, please refer to FIG. 5 in conjunction with the schematic block diagrams of FIGS. 3 and 4. The method shown in FIG. 5 is as follows:

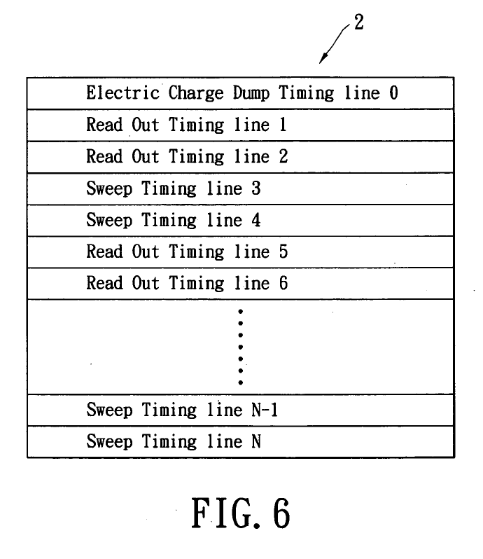

First, when the digital image-capturing apparatus 1 is performing an image processing procedure, in order to achieve the effect of accelerating image capturing process for the image processing procedure, the control unit 10 proceeds by dividing a frame that is captured by the imaging device 16 (S401). Therein the step of dividing a frame vertically or horizontally is by using a plurality of dividing lines, and every dividing line is consistent with the display width of the frame as a dividing unit, and thereby the dividing result is that a plurality of regions are formed out of the frame. As shown in FIG. 6, every region can be seen to have the same length as the displayed width of the frame.

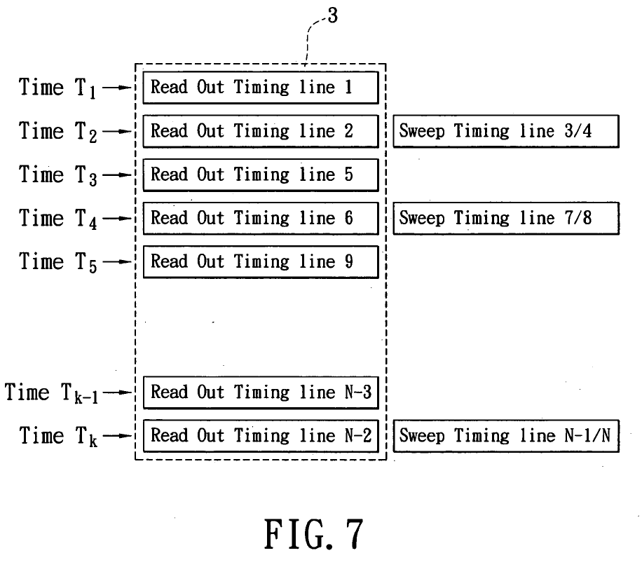

Subsequently, defining each regions of the frame to correspond to either an electric charge dump timing, a read out timing, or a sweep timing; and then defining a window of interest region (S403). How step S403 is executed is shown by FIG. 6 and FIG. 7, wherein FIG. 6 shows frame 2 with regions that have been correspondingly defined to the timings. Therein the region of frame 2 line 0 has been defined as a region of electric charge dump timing, more specifically the region of frame 2 line 0 is permanently defined for the usage of electric charge dump timing. Subsequently, frame 2 alternatively and selectively defines a plurality of regions either the regions of read out timing or the regions of sweep timing. For example, frame 2 lines 1 and 2 are defined as regions of read out timing; frame 2 lines 3 and 4 are defined as regions of sweep timing, and the following regions of frame 2 regions are defined going after this selecting pattern until the last line of frame 2, which is frame 2 line N. Thereby, every continuous regions of read out timing and every continuous regions of sweep timing are adjacently located with one of the dividing lines in between. Specifically in the present embodiment, there is a dividing line between line 2 and line 3, and also between line 4 and line 5.

To be noted, the regions of read out timing and the regions of sweep timing shown in FIG. 6 are following the pattern of uploading 2 read out timing then eliminating 2 sweep timing. However, the present invention is not limited thereby, all embodiment that has m number regions of read out regions and n number regions of sweep regions are deemed encompassed by the present invention. In other words, the regions of the frame are respectively either the regions of read out timing or the regions of sweep timing (except of course the previous mentioned region of electric charge dump timing), wherein every m number regions of read out timing and every n umber regions of sweep timing are adjacently located with one of the dividing lines in between. Furthermore, the aforementioned m and n are each integer value that is greater than 1 or equal to 1.

FIG. 7 shows the scanning timing diagram that has been performed according to the dividing result of Frame 2 as displayed in FIG. 6. Therein the main characteristic of the timing diagram is that the regions of read out timing neighbors regions of sweep timing are located on the same line, therefore the length of timing for scanning each line of the imaging device 16 is different, and thereby the timing generator unit 12 of the present embodiment correspondingly generates and provides dynamic timing for each lines with various length. For example, in FIG. 7, the first timing T₁ is provided for use by the region of read out timing in frame 2 line 1, the second timing T₂ is provided for use by the region of read out timing in frame 2 line 2 and the regions of sweep timing in frame 2 lines 3 and 4, the third timing T₃ is provided for use by the region of read out timing in frame 2 line 5, the fourth timing T₄ is provided for use by the region of read out timing in frame 2 line 6 and the regions of sweep timing in frame 2 lines 7 and 8, and the subsequent timing is provided for use by the subsequent regions of the frame 2 repeating the aforementioned patterns.

Finally, in FIG. 7, set those regions corresponding to the read out timing as a window of interest region 3, due to the fact that the window of interest region 3 does not include those regions corresponding to the sweep timing, therefore the image data of the window of interest region 3 can be retrieved by the imaging device 16 to be used for image analysis processing (such as autofocus) and for live view display of digital image-capturing apparatus 1. Furthermore the output timing of FIG. 7 is dynamic; the image data retrieved by the imaging device 16 is continuous and does not include dummy data of the sweep timing.

Please refer to FIG. 5 again, once the step S403 has been completed, the control unit 10 can then control the timing generator unit 12 to perform image processing procedure (such as S405) according to the defining result of the step S403, therefore the timing generator unit 12 can control the image retrieval of imaging device 16 according to the dynamic timing output as shown in FIG. 7. As a result, the control unit 10 proceeds to determine if every line of frame 2 has completed performing the image processing procedure (such as S407), if the determination result is no, then return to step S405 and continue the cycle, otherwise proceed to the next image processing procedure for frame 3 (such as step S409).

For the aforementioned FIG. 7, once the image processing procedure for a frame 2 has been completed, the final retrieved image data can not only be used for direct image analysis (such as autofocus analysis), but may also be simultaneously displayed on display unit 18. Furthermore, in order to retain the same display ratio of the original image frame, this captured image data may first underwent an image enlargement process, then be outputted and displayed on the display unit 18.

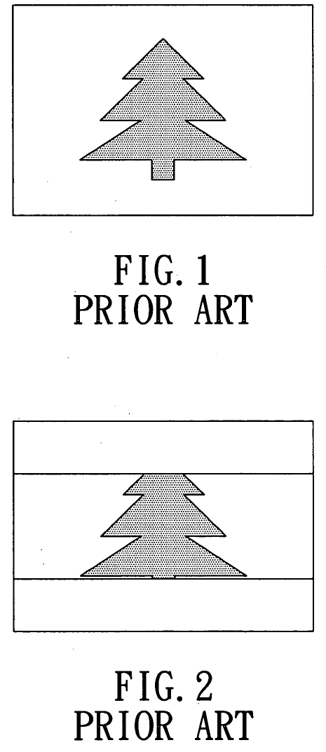

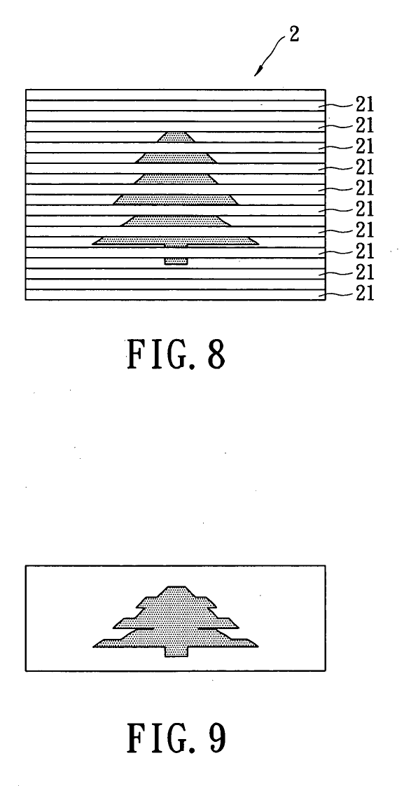

Next please see original image frame of FIG. 1 in conjunction with FIGS. 8 and 9 for explanation of the operation result, wherein the operation result is the result from the method of accelerating image capturing process according to the present invention. FIG. 8 shows a schematic diagram of the original image frame of FIG. 1 after being divided (such as step S401) and defined (such as step S403) as according to the present embodiment. Therein, some of the image data of lines 21 located within frame 2 has been eliminated according to the aforementioned sweep timing, therefore the retrieved image data included within frame 2 is greatly reduced, and thereby the effect of accelerating image capturing is achieved. FIG. 9 shows the result after the image processing procedure (such as step S405). Therein, FIG. 9 primarily eliminates the image data of the regions of frame 2 corresponding to the sweep timing, therefore the remaining image data may be combined into a continuous data. Since the image of FIG. 9 is basically the original image of FIG. 1 with alternating lines eliminated, therefore the overall ratio of the original image frame is still maintained.

As per the aforementioned embodiments, the technical characteristic of the present invention is that the timing generator unit 12 can dynamically generate and provide different lengths of timing to the imaging device 16 for image processing procedure, so that the present invention can selectively retrieve partial image data from a frame 2 in a simple fashion, furthermore the retrieved image data is continuous, and can be used to display on a display unit since the retrieved image data maintains the same overall ratio as the original image frame. Therefore when an image processing procedure of the present invention is applied for autofocus, the speed of the autofocus is increased, furthermore while autofocus is occurring the display unit 18 can still simultaneously display the retrieved image from imaging device 16. There is no issue like the prior art where while autofocus is performing the display unit 18 is temporarily halted.

The aforementioned descriptions represent merely the preferred embodiment of the present invention, without any intention to limit the scope of the present invention thereto. Various equivalent changes, alternations, or modifications based on the claims of present invention are all consequently viewed as being embraced by the scope of the present invention.

What is claimed is:

1. A method of accelerating image capturing process, suitable for use for an image processing procedure of a digital image-capturing apparatus, the steps of the method comprising:
dividing a frame that is captured by the digital image-capturing apparatus by using a plurality of dividing lines, so as to form a plurality of regions;
defining the regions as respectively either a region of read out timing or a region of sweep timing, wherein every m number regions of read out timing and every n number regions of sweep timing are adjacently located with one of the dividing lines in between;
setting the regions of read out timing as a window of interest region; and
outputting the timing signal required by the read out timing and the sweep timing so as to capture the image data that is contained within the window of interest region.

2. The method of claim 1, wherein at least one of the plurality of regions divided from the frame is defined to be a region of electric charge dump timing.

3. The method of claim 2, wherein before outputting the timing signal required by the read out timing and the sweep timing, the timing signal required by a electric charge dump timing is first outputted.

4. The method of claim 1, wherein the image processing procedure is an autofocus procedure for the digital image-capturing apparatus.

5. The method of claim 1, further comprising the steps of:
displaying the captured image data that is contained within the window of interest region on a display unit of the digital image-capturing apparatus.

6. The method of claim 5, wherein the captured image data contained within the window of interest region has underwent an image enlargement process before displaying on the display unit.

7. A digital image-capturing apparatus, suitable for use for an image processing procedure, comprising:
an imaging device, for providing image capture;
a timing generator unit, for providing a plurality of timing signals required for the operation of the imaging device;
a driving unit, coupled to the timing generator unit, for driving the imaging device according to the timing signals provided by the timing generator unit; and
a control unit, coupled to the imaging device and the timing generator unit so as to control the operation of the digital image-capturing apparatus, comprising:
a dividing module, for dividing a frame that is captured by the imaging device by using a plurality of dividing lines, so that the frame forms a plurality of regions;
a differentiation module; for defining the regions as respectively either a region of read out timing or a region of sweep timing, wherein every m number regions of read out timing and every n number regions of sweep timing are adjacently located with one of the divided lines in between;
a window of interest selection module, for setting the regions of read out timing as a window of interest region; and
an output module, for controlling the timing generator unit so as to output a timing signal required by a read out timing and a sweep timing and thereby capture the image data that is contained within the window of interest region.

8. The digital image-capturing apparatus of claim 7, wherein at least one of the plurality of regions divided from the frame is defined to be a region of electric charge dump timing.

9. The digital image-capturing apparatus of claim 8, wherein before the timing generator unit outputs the timing signal required by the read out timing and the sweep timing, the timing signal required by a electric charge dump timing is first outputted.

10. The digital image-capturing apparatus of claim 7, wherein the image processing procedure is an autofocus procedure for the digital image-capturing apparatus.

11. The digital image-capturing apparatus of claim 7, further comprising:
a display unit, coupled to the control unit, and thereby perform display according to the control of the control unit.

12. The digital image-capturing apparatus of claim 11, wherein the control unit controls to display the captured image data that is contained within the window of interest region on the display unit.
